(19) United States
(12) Patent Application Publication
(10) Pub. No.: US 2021/0014733 A1
(43) Pub. Date: Jan. 14, 2021

(54) A METHOD FOR CHARGING OFFLOAD TRAFFIC

(71) Applicant: Athonet S.r.l., TRIESTE (IT)

(72) Inventors: Hesham SOLIMAN, South Melbourne, VIC (AU); Gianluca VERIN, Pozzoleone (VI) (IT)

(73) Assignee: Athonet S.r.l., TRIESTE (IT)

(21) Appl. No.: 16/981,879

(22) PCT Filed: Mar. 20, 2019
(86) PCT No.: PCT/EP2019/057006

§ 371 Date: Sep. 17, 2020

(30) Foreign Application Priority Data
Mar. 20, 2018 (IT) 20201800002192
Nov. 6, 2018 (EP) PCT/EP2018/080366

(51) Int. Cl. H04W 28/08; H04M 15/00; H04W 8/18; H04L 29/06

(52) U.S. Cl. CPC H04W 28/0942; H04M 15/66; H04W 88/16; H04W 8/18; H04L 63/1425; H04M 15/64

(57) ABSTRACT

A method for charging a user identified by a user identifier accessing a service in a LTE telecommunication network is provided. The network includes a base station, a core network with an enhanced serving gateway function, and an IP network. The method includes:
analyzing all traffic packets originating from the user which connects to the network;
forwarding the traffic packet to the core network if the traffic packet or the user sending it does not satisfy the policy or the service is not available at the edge site;
offloading traffic packet outside the core network if it meets the policies configured in the serving gateway; routing of the traffic packet is done by the serving gateway; and
sending from the serving gateway information about the offload traffic packets to the packet data network gateway located in the core network or to an Online Charging System.

### TECHNICAL BACKGROUND

MEC is an acronym for Mobile (or Multi-access) Edge Computing and is a term that refers to the concept of bringing networking, application and computing capabilities to the edge of the network, where it is closer to the device consuming such resources. To understand the interest in this area of work, one needs to look at typical mobile network deployments today. FIG. 1 shows a simplified network deployment. For devices communicating to application servers in the Internet, traffic needs to traverse the large mobile network core, pass through transit networks and arrive at the application at the other end. The same happens in the reverse direction. This has been the case for decades; however, as mobile networks become more complex and their use cases increase to include ones that were rarely considered in the past, new requirements arise.

A number of studies and business cases have shown that the above model is inefficient and introduces non-deterministic or unacceptable delays for certain type of services. Current MEC solutions in the industry address the cloud capabilities and IT services at the mobile network edge which has peculiar needs.

In the quest to bring the application ever closer to the user, the MEC industry focused on enabling different use case scenarios for pilot purposes rather than serving a generic application need (e.g. low latency). Two different approaches to MEC have emerged over the years. One approach distributes the entire core or at least the SAE-GW (SGW+PGW) at the network edge and allows traffic to be offloaded, e.g., based on the APN configured in the PGW. The “private network” approach is very useful in the context of an enterprise that needs to create a dedicated network. However, this approach is limited by the fact that the entire APN traffic is locally offloaded. In other use cases the operator may need to have a more granular control over the type of traffic that should be offloaded. FIG. 2 illustrates such approach.

A second approach to MEC is “Bump in the Wire” (BIW) or “Bump in the Stack”, which introduces a new function that intercepts signalling and data traffic on the S1 interface and steer it to the local MEC applications. FIG. 3 illustrates a simplified BIW approach.

seen in FIG. 3, the BIW function intercepts both signalling and user traffic and based on configured policies, decides to steer some traffic out towards the application outside the core network. This approach has several limitations as discussed below.

“bump in the wire” approach to MEC has several limitations which will hamper its ability to reach widespread adoption.

limitations are:

IPec and security: IPsec can be used to protect the S1 interface between the eNBs and the core network. However, the BIS solution needs to inspect S1 messages, this is an elementary requirement for it to work. Therefore, this forces an operator to either disable IPsec, or limit the BIS entity's location to somewhere behind the IPsec gateway to intercept data in the clear. If the latter option is chosen, it limits an operator's placement of the MEC platform in selected few data centres behind the firewall which reduces the ability to distribute the MEC platforms. Such reduction in distribution limits the desired benefit of a MEC platform to be as close as possible to end devices. The alternative is to allow the MEC platform to “break” the IPsec tunnel which is a riskier approach from a security point of view and requires the MNO to share very specific and secret information such as the IPsec encryption keys which needs to be used also by the MEC platform.

IDLE user reachability: A MEC application relying on BIW, at best, will add significant delays to the connection initiation with an IDLE device. At worst, the application cannot initiate a connection towards a user that goes into IDLE mode. This is because an application sending IP packets on the Downlink, needs to detect whether the user is in IDLE mode and if so, send packets to the UE's last known address, which will need to be routed through the PGW to trigger the paging procedure.

The application has no knowledge about the UE's status, whether the user is unreachable because the device has gone out of the MEC domain or if the device has simply gone into IDLE mode. This is quite an important limitation for an application that needs to be responsive and close to the user.

Lawful Intercept of a selected user using BIW is possible only by adding complexities (e.g. new non-standard 3GPP network functions and interfaces) into the operators' network. The lack of standardized approach may pose problems with national authorities.

Traffic charging: With BIW, it is difficult to produce Charging Data Records (CDR) for steered traffic. This is because the MEC platform does not own all the information such as IMSI, IMEI, IP address, APN, cell level user location, among others, which are necessary for producing CDRs. Charging can only be done by adding complexities (e.g. new non-standard 3GPP network functions and interfaces) into the operators' network. Proposals to address all the above issues require adding new boxes into the operator's core network which in turn requires modification of existing network design and policies—adding costs, complexity and footprint to the solution which diminishes the economics of edge deployments. The architecture of such an approach cannot be easily upgraded to support 5G, which affects its lifetime utility and economics. Also, solutions that use proprietary interfaces result in vendor lock-in, thus limiting the ability to offer cost effective and efficient solutions. In addition, if traffic is offloaded at the edge site, problems may arise in charging the user accordingly, considering all the traffic used, the one at the edge site and the one via the core network.

### SUMMARY OF THE INVENTION

Whilst the mobile edge cloud has often been talked about, a clean solution to enable it in the mobile network is lacking. As seen above, solutions such as BIW are hampered by security concerns, charging, lawful interception limitations and lack of support for “push” applications. On the other hand steering the entire APN traffic locally (with the SAE approach) may not be appropriate for most deployments. In order to allow an operator to steer traffic flexibly based on either users' identifiers or uplink classifiers that may contain complex filters, an intelligent traffic steering function is required in the core network. In the present invention it is proposed to position the SGW into each MEC platform. This allows an easy introduction of the MEC platform into the operator network which can put a MEC application following these steps:
Ensure S11, S5 and Bx (optional) network reachability on the Core Network side by the MEC platform
Ensure the S1-U network reachability on the RAN side by the MEC platform
Update the operator's DNS in order for the MME to select the MEC platform for the Tracking Area where the eNBs that need to be served are located

The MEC application connects to the MEC platform through ETSI MEC API's. The MEC platform gathers data from various components in the network and uses them to respond to the MEC application's requests. The SGW-LBO is the routing engine of the MEC solution, and enables local breakout based on per-user or per-traffic stream policies provisioned via API.

The invention thus relates to a method for charging a user identified by a user identifier accessing a service in a LTE telecommunication network, said telecommunication network including a base station, a core network, an IP network external to said core network and the base station, the edge site, which is logically part of the core network, and which may include an edge server offering services.

The invention relates to a method for charging a user identified by a user identifier accessing a service in a LTE telecommunication network, said telecommunication network including a base station, a core network, a IP network external to said core network, wherein the SGW core network function, which can be located near the base station, is extended so as to enable it to perform the following:
Analyse all traffic packets originating from the user which connects to the network;
forward the traffic packet to the core network if the traffic packet or the user sending it does not satisfy the policy or the service is not available;
sending from the serving gateway information about the offload packets to the packet data network gateway (PGW) located in the core network or to an Online Charging System (OCS).

The invention also relates to a method of charging a user identified by a user identifier accessing a service in a LTE telecommunication network, said telecommunication network including a base station, a core network, an IP network external to said core network and the base station, an edge site which includes an edge server offering services, the method including:

a. analyzing at the “edge” all traffic packets originating from the user which connects to the65 network;

b. checking whether the service is available at the server of the edge site or whether it should be steered out of the core network;

c. routing packets on the basis of a forwarding policy which is based either on the user identifier or on information contained in the IP packet portion of the checked traffic packet;

d. offloading traffic packet of the desired requested service if the forwarding policy is met;

e. forwarding the traffic packet to the core network if the traffic packet or the user sending it does not satisfy the policy or the service is not available at the edge site;

f. wherein the step of routing the traffic packet to either the core network, or out of the core network includes rerouting the traffic packet by the serving gateway;

g. sending from the service gateway information about the offload packets to the packet data network gateway located in the core network or to an Online Charging System.

In another aspect, the invention relates to a mobile telecommunication network including:
a plurality of base stations for the connection to an user,
an edge site associated with a base station of the plurality, the edge site including an edge server and the serving gateway,
a core network,
an IP network,
wherein the serving gateway is configured to:
   analyze all traffic packets originating from said user,
   check whether the traffic packet requests a service;
   route the traffic packet either to the core network or out of it based on a forwarding policy which is based either on the user identifier or on information contained in the IP packet portion;
   wherein the step of routing the traffic packet includes forwarding by the serving gateway.

Further, the serving gateway may be further configured to send information about the offload packets to the packet data network gateway located in the core network or to an Online Charging System.

The method of the invention enables wireless users to access the content of services “locally” according to a given policy. Such services are for example, video streaming services, Skype calls or video-calls, YouTube server, and so on.

A telecommunication mobile network is used, which includes a core network and an external IP network (external to the core).

The meaning of “external” IP network relates to a network external to the core network, which is clearly defined in 3

GPP standards. Such an IP network is the Internet, a private corporate network or an operator's IP network. There is no need that the external IP network belongs to a different operator: core network and IP network, external to the core network, can belong to the same operator of a wireless communication network.

The term offloading means to direct traffic outside the core network.

The user connects to the communications network via a radio access network (“RAN”). The RAN is connected to a core network which in turn allows connection to additional networks than the external IP network, such as public switched telephone network (“PSTN”), internet, and other IP networks.

A user may be any type of device configured to operate and/or communicate in a wireless environment. By way of example, the user may be configured to transmit and/or receive wireless signals, and may include a user equipment, a mobile station, a fixed or mobile subscriber unit, a pager, a cellular telephone, a personal digital assistant (“PDA”), a Smartphone, a laptop, a netbook, a personal computer, a wireless sensor, consumer electronics, and other transmitter/receivers known in the art. The user can be connected to a human or also to a machine.

The user is identified by a user identifier, which is for example an International Mobile Subscriber Identity (IMSI) present in a Subscriber Identity Module (SIM) card, an Universal Subscriber Identity Module (USIM), Removable User Identity Module (R-UIM), a CDMA Subscriber Identity Module (CSIM), a virtual SIM and/or a given terminal serial number such as an International Mobile Equipment Identifier (IMEI) of the user. Any other user identifier can be used, as long as it uniquely identifies the user.

The RAN may include one or more base stations configured to transmit and/or receive wireless signals within a particular geographic region, which may be referred to as a cell.

According to the standard, the user requests a connection to the network via the RAN.

The base stations, referred to as eNodeBs (eNBs), provides wireless communication services to users registered therewith.

Each of the eNodeBs is connected to a Serving GateWay (SGW) via an S1 interface. More than one SGW may be provided in a telecommunications network. The SGW may receive data for transmission to the users via the eNodeB from the Internet. Uplink data is transmitted in the other direction, from the user. An X2 interface is provided between eNodeBs in order to allow the exchange of information therebetween and perform handovers.

Conventionally, if the user, typically using an application installed thereon, needs to perform a transaction (such as the exchange of data) with a remote server, a communication session between the server and the user is established. Communication session data is sent and the eNodeB, the SGW and PGW. The transfer of data to/from the remote server to the mobile terminal can take some time due to the distance and the number of network elements/nodes through which the data must travel, and also requires a sufficient capacity in the backhaul between the eNodeB and the core network.

In order to reduce latency and backhaul requirements, it has been proposed to provide services at the “edge” of the mobile telecommunications network - that is, somewhere nearer to the location of the eNodeBs. Therefore, in this invention, an edge server close to the eNodeB may be present. For example, the edge server may be provided at the same location as its respective eNodeB and may be located in the same housing as the eNodeB. Alternatively, the edge server maybe located elsewhere in the core network or anywhere on the Internet.

The edge server may provide a plurality of processing functions that allow services, such as those provided by the remote server to be provided locally at the edge server. The processing functions may be implemented by virtual machines on edge server.

For example, if, instead of the remote server providing to the user a service of streaming a popular music video, by providing this service by virtual machine on the edge server, latency and backhaul bandwidth requirement can be reduced. The content is stored on the edge server and provided on request to the mobile device by the virtual machine. In this example, the application at the user's device receives the content and enables the video to be viewed by a user.

As the edge server (and virtual machine) is closer to the eNB, with which user is registered, there is no need for the content to be transmitted via the backhaul connection to the remote server. In order to properly perform this offload of traffic, according to the present invention a serving gateway (SGW-LBO) is present.

All packets coming from the user are analysed. The serving gateway, routes the packets on the basis of a policy described below.

The policies described in this invention apply to the user's traffic. Standard signalling or control plane traffic is not affected by such policies. If the policy applies to the user's traffic, the SGW-LBO routes such traffic accordingly. Such routing may result in traffic being offloaded out of the core network (either to a local server or to a server on the Internet) or sent as per normal routing to the core network (PGW).

The serving gateway is a standard 3GPP server and the acronym SGW is normally used. In this case it is called SGW-LBO where LBO stands for Local Break Out.

The SGW-LBO is an enhanced 3GPP standard compliant SGW which has the capability of selectively steering the traffic locally according to policies that are provisioned. Such policies may be provisioned manually or dynamically via an Application Programming Interface (API).

When the user attaches, the MME authenticates the user and selects the SGW and PGW pairs based on APN selection and eNodeB's Tracking Area. Once the SGW-LBO is selected by the MME for the signalling, the MME sets up over the S11 interface the default bearers with the SGW and PGW using the S5 interface as per standard 3GPP procedure. The relevant information exchanged during the signalling phase is then matched against the traffic steering policy in order to install the steering rules into the SGW User Plane component.

When the user's default bearer is configured, the SGW Control plane function learns a number of parameters identifying the user and their traffic, including the permanent UE identity, APN and IP address assigned. At this point the policy criteria for offloading that have been received via API or other forms of management is checked and—in case the criteria are matched—it installs the rules in the uplink (UL) classifier and Downlink (DL) table rule which provides the user plane (UP) with the needed steering criteria. Internally this part can be implemented using a “virtual” dedicated bearer which may not exist, but is similar to the dedicated bearers used to classify traffic and enforce policies.

The UL traffic coming from the S1 interface can be matched based upon UE identity, IP address, IP source and destination, protocol number, port source and destination, DSCP value (useful for encrypted traffic). In case the traffic matches, the GTP traffic is decapsulated and sent to the LBO interface for traffic offloading. The UL traffic matches first the GTP TEID and then UL traffic rule. Network Address Translation (NAT) is not necessary although possible for packet directed to the LBO interface. If the policy does not match, the traffic is sent over the S5 interface according to the standard 3GPP procedure. The DL traffic coming from the LBO interface is received on different logical interfaces (SGi like with associated different VRFs) which do the matching based on UE IP address and Traffic Filter Template (TFT) rules and returns the GTP TEID to be used for DL traffic over the S1 interface.

The offload function is responsible to steer the traffic according to the Uplink Filter Classifier installed in the User Plane (UP). The offload function is composed by a control plane which is responsible to gather information on the users, IP address assigned and user plane components which is responsible for the steering of the traffic (as opposite to the simple forwarding that is typical to any SGW's UP.

The offload function, similarly to a standard SGW generates 3GPP standard CDRs that can be exported using the Bx interface, or communicated to the OFCS portion using the Ga interface. Such interface allows to trace offline the traffic that is offloaded which cannot be accounted in the PGW.

In addition, the SGW-LBO allows to apply online charging policy also to the traffic to be offloaded. Normally, the PGW is responsible for the communication with the Online Charging System (OCS). Preferably, the PGW regularly checks whether a user has enough credit to continue with the current service. Post-paid users may have data usage limits that, when exceeded, can result in throttling the current connection or stopping it altogether. On the other hand, pre-paid customers would also need to be auctioned if they used up their credit.

Preferably, a OCS is provided, and the PGW is connected to the OCS. Preferably this connection is via a Gy interface.

This can be done for example using a diameter based Credit Control interface, which is similar to the Gy interface and allows the BSS (base station subsystem) to grant the unit of traffic and time also for the traffic that is steered.

Having the traffic steered “out” of the network by means of the SGW before it arrives at the PGW would bypass this function and therefore negatively affect the network operation.

For this purpose, information regarding the offload traffic is send from the SGW to the PGW.

In one embodiment of this invention, the method includes sending a copy of the offload packets from the serving gateway to the packet data network gateway.

If the SGW at the edge is offloading packets, the PGW at the core is not aware of the offload and cannot charge the user accordingly. In order to have the complete overview of the packet the user receives, both offload and from the core network, the SGW sends a copy of the offload packets to the PGW, which may be connected to the OCS and thus all the traffic can be charged accordingly.

In another embodiment of this invention, the method also includes marking the copy of the offload packet. Preferably, the copy of the offload packets when reaches the PGW is then discarded. In order to identify those packets that are simply the copy of the offload packets, these copies are marked.

More preferably, the marking includes reserving a GTP tunnel id and marking the copy with the reserved id. Preferably generating by the serving gateway records containing a traffic usage of offload packets on a per user basis.

In another embodiment of the invention, the SGW-LBO generates records containing the traffic usage for local breakout on a per customer basis. The traffic records generated would be used by the PGW, added to the non-breakout traffic usage to obtain accurate information about the user's data usage.

Preferably, the method includes extending the serving gateway so that it implements a Gy interface to communicate with the Online Charging System.

In an alternative embodiment, instead of passing through the PGW, the SGW itself communicates with the OCS, supporting a Gy interface.

In a different aspect of the invention, the invention relates to a method to perform handovers when the user moves from one MEC domain to another MEC domain. I.e. an application level handover between two different applications within two MEC coverage zones.

The invention thus relates to a method to perform an handover in a mobile telecommunication network, the network including:
a plurality of base stations for the connection to an user,
a first and a second MEC application associated with a first and a second base station of the plurality, the first and second edge sites including a first and a second edge server and may have a first and a second serving gateway, wherein the first and second edge server support first and second applications,
a core network,
an IP network,
wherein the serving gateway is configured to:
analyze all traffic packets originating from said user,
check whether the traffic packet requests a service;
route the traffic packet either to the core network or out of it based on a forwarding policy which is based either on the user identifier or on information contained in the IP packet portion;
wherein the step of routing the traffic packet includes forwarding by the first or second serving gateway,
the method including:
   assigning an anycast address to the first and second edge application,
   using an anycast address routing in case of handover between the first and second edge application.

Alternatively, still in case of handover, a different provision can be made.

The invention thus relates to a method to perform an handover in a mobile telecommunication network, the network including:
a plurality of base stations for the connection to an user,
a first and a second edge sites associated with a first and a second base station of the plurality, the first and second edge sites including a first and a second edge server and a first and a second serving gateway, wherein the first and second edge server support first and second applications,
a core network,
an IP network,
wherein the first and second serving gateway are configured to:
analyze all traffic packets originating from said user,
check whether the traffic packet requests a service;
   route the traffic packet either to the core network or out of it based on a forwarding policy which is based either on the user identifier or on information contained in the IP packet portion;
   wherein the step of routing the traffic packet includes forwarding by the first or second serving gateway,
method including:
   in case of handover from the first base station to the second base station, sending from the first edge server an application-specific redirect message to indicate that the session should be continued with the second edge server.
   Transferring user context from the first edge server to the second edge server.

New developments in 3GPP emphasise the need for a Service-based Architecture (SBA) where network functions are distinctly divided into services that communicate with each other using standard protocols. These developments took place in 4G standards and are expected to continue in 5G standards. This includes a clear separation of the Control Plan (CP) and User Plane (UP). The CP is responsible for the communication of information about ongoing sessions or about the mobile network subscribers. This includes everything from address allocation to policy retrieval, QoS enforcement and charging. The method of the invention therefore takes into consideration how the SGW-LBO may obtain the information needed to implement the policy to offload traffic.

In this aspect, the invention includes a method of offloading traffic packet in a LTE telecommunication network by a user identified by a user identifier accessing a service, said telecommunication network including a base station, a core network, an IP network external to said core network and the base station, an edge site which includes an edge server offering services, wherein the LTE communication network includes a serving gateway comprising a SGW-U and a SGW-P and a packet data network gateway comprising a PGW-U and PGW-C a the method including:
analyzing at the “edge” site all traffic packets originating from the user which connects to the network;
routing the traffic packet to the edge site on the basis of a forwarding policy which is based either on the user identifier or on information contained in the IP packet portion of the checked traffic packet;
transferring from PGW-C to the SGW-C and from the SGW-C to the SGW-U information about the user's identity, the corresponding allocated IP address and APN;
forwarding the traffic packet to the core network if the traffic packet or the user sending it does not satisfy the policy or the service is not available at the edge site;
wherein the step of routing the traffic packet to either the core network, or out of the core network to the edge site includes rerouting the traffic packet by the serving gateway.

Preferably, the method includes:
storing the information about the user's identity, the corresponding allocated IP address and APN at the PGW-C;
communicating the above information to the SGW-C once the bearer assignment to the user is executed.

This architecture, while providing a number of benefits, presents a challenge to the LBO approach presented above. In order for the SGW-LBO to steer traffic “out” of the core network, it needs to be aware of policy decisions that can be mapped to incoming traffic on the uplink. This requires knowledge of the ultimate customer's identity and knowledge of the traffic classifiers. It also requires knowledge of the customer's APN. Such information is not shared in the CP-UP split architecture.

### BRIEF DESCRIPTION OF THE DRAWINGS

The invention will be better detailed with reference to the appended drawings, where:

FIG. 1 shows a typical operator's deployment (prior art);

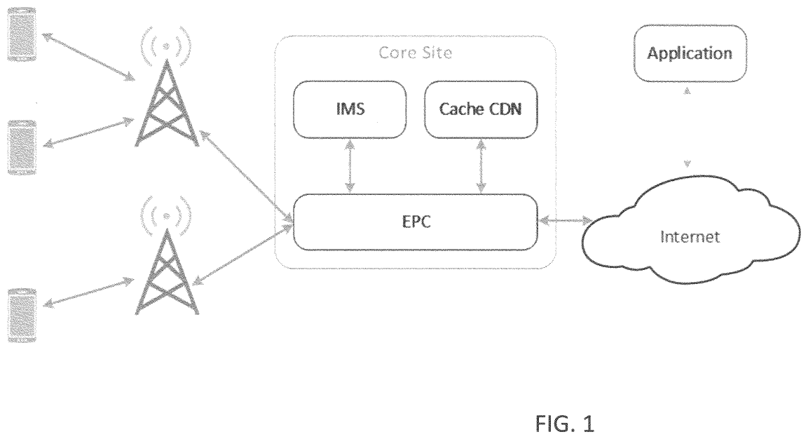

FIG. 2 shows a distributed Core as a MEC solution (prior art);

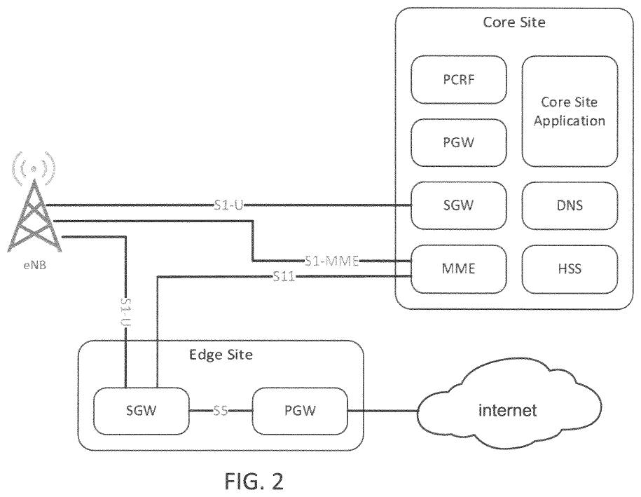

FIG. 3 shows an overview of the “Bump in the Wire” approach (prior art);

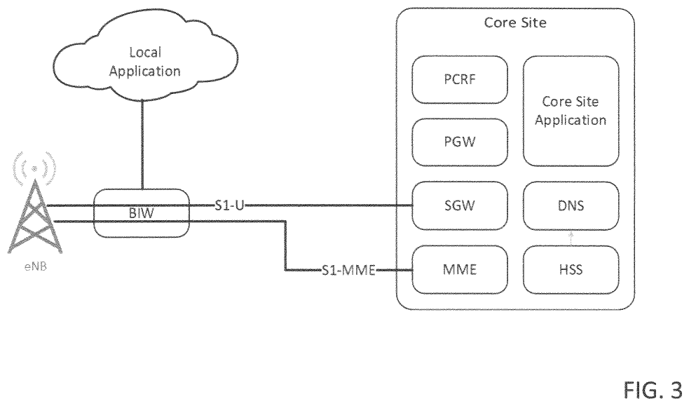

FIG. 4 shows a MEC solution architecture using the SGW-LBO approach;

FIG. 5 shows the LI approach;

FIG. 6 shows CP-UP split in the core network;

FIG. 7 shows PGW-C to SGW-C to SGW-U sequence;

FIG. 8 shows MEC-SGW-C-SGW-U sequence; and

FIG. 9 shows MEC adoption and evolution to 5G.

### DETAILED EMBODIMENTS OF THE INVENTION

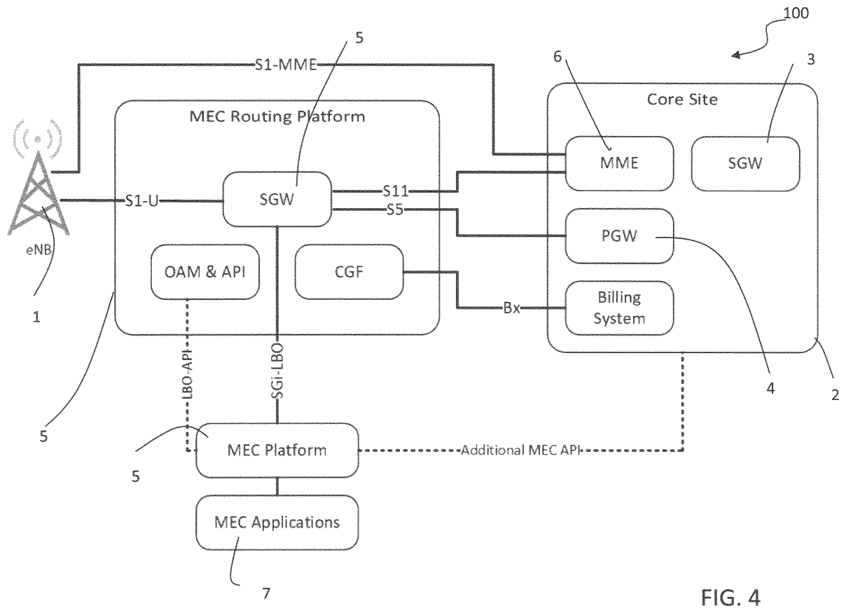

In FIG. 4 a LTE network 100 is depicted. The LTE network includes a plurality of base stations 1, referred to as eNodeBs (eNBs), to which a user may connect. The LTE network 100 includes a core network 2, which defines an “edge” with an edge server and includes a SGW 3 and a PGW 4. The LTE network 100 also includes a MEC platform 5, preferably more than one platform MEC.

FIG. 4 shows the default 3GPP interfaces that should be supported by the MEC platform 5 that uses the SGW with a special Local Break Out (LBO) functionality which allows to selectively steer the data traffic to a local application.

The SGW-LBO connects externally via the following interfaces:
S1-U: GTPv1-U based interface used to connect the SGW 3 to the eNBs 1;
S5: GTPv2-C and GTPv1-U based interface used to connect the SGW 3 to the PGW 4 in the core site;
S11: GTPv2-C interface used to connect the SGW 3 to the MME 6 in the core site;
SGi-LBO: interface used to receive and transmit data to/from an external network including local private LAN (Intranet), Internet, or a services network;
Bx: interface used for fetching the CDRs. This interface allows billing systems to get the CDRs for offline charging.

Other interfaces include:
Diameter based Credit Control interface (Gy) for online charging;
X1, X2, and X3, or H1, H2 and H3 interfaces for LI purposes;

Configuration management to provision LBO rules based on parameters such as IMSI, APN and 5 tuples, among other possible traffic identifiers.

The routing engine may contain one or more of the following functionalities:
The 3GPP compliant SGW with local break out capabilities
The 3GPP standard compliant CGW which collects KPIs and produces CDRs
Management and API functionalities to interact with the MEC platform, traffic management, automatic deployment and configuration
Optionally Lawful intercept functionalities
Optionally SGi services can also be provided as part of this such as:
   TCP optimization
   URL logging
   DPI and content filtering
   NATing, NAT44 and NAT64 and Firewall
   Content Delivery Network extension

The MEC platform 5 includes MEC applications 7. These MEC applications 7 that can be hosted in the platform may cover a wide range of applications which have low delay and backhaul efficiency requirements, such as:
Vehicle to Infrastructure V21, Infrastructure to Vehicle I2V, and V2X communication
Video streaming
Machine to machine communication
Voice and Video communication
Content Delivery Network (CDN) and content caching
Augmented reality
Emergency services and public safety
Enterprise intranet extensions

The SGW-LBO can also be implemented using the 5G architecture where the SGW control function is replaced by the SM, the data traffic is steered by the UPF (User Plane Function) the external Policy Function can be co-located into the PCF.

The MEC application 7 connects to the MEC platform 5 through MEC API's, for example ETSI MEC API's. The MEC platform 5 gathers data from various components in the network and uses them to respond to the

MEC application's requests. The SGW-LBO is the main component of the routing engine of the MEC solution, which enables local breakout based on per-user or per-traffic stream policies. Policies may be enforced via an API optionally controlled by a Policy Function which can be centralized, common to many MEC platform 5 and implemented as an extension of the traditional PCRF.
The policies for traffic offloading can be based on any of the following parameters or a combination of:
Source IP address (IPv4 or IPv6) and netmask
Destination IP address (IPv4 or IPv6) and netmask
Source and destination port and port range
Protocol number
DSCP
IMSI and IMSI range
APN name
Others.

The SGW-LBO can be deployed distributed and at the edge of the network, while interoperating with the mobile network operator's MME and P-GW via the exposed 3GPP standard interfaces S11 and S5/S8, respectively. The SGW-LBO is a standard compliant 3GPP SGW node part of the MEC platform 5 that is controlled and coordinated by the operator from the central core. The SGW-LBO allows to do traffic breakout towards special application servers also located in the platform.

In case the SGW-LBO is switched off or the entire MEC platform 5 becomes unavailable, the national SGW will be selected by the MME according to the 3GPP indications and the DNS priority ranking returned to the MME.

A MEC platform 5 based on the SGW/LBO approach may bring one or more of the following benefits:
easy introduction and distribution into the operators' network using standard 3GPP interfaces and procedures with minimum impact on the operator's network and no service interruption
no compromise on network security
every application will work seamlessly as there is no assumptions on UE state activity
standard 3GPP support of inter-MEC and MEC to National network handover
low latency benefits
“5G like” architecture using current 4G network, which will be software upgradable to support 5G protocols.

The purpose of MEC is to ensure that the application is as close as possible to the mobile, to avoid further delays. Hence, as the mobile device moves, there is a need to enable the operator to perform a handover between MEC applications.

The handover between MEC applications 7 is another layer of handover on top of the mobile network handover. Since the mobile device doesn't change its IP address during a handover, there is a need to seamlessly re-route the relevant stream to the “new” MEC application 7 and perform the same action in the downstream direction.

The above can be achieved in multiple ways:
1. in one embodiment of this invention, anycast addresses can be used. Each MEC application 7 is assigned an anycast address. Anycast address routing ensures that the infrastructure forwards the traffic to the nearest MEC application 7. This ensures that routing of upstream packets is sent to the right application. Downstream traffic needs to be bound to a specific MEC platform 5 for any MEC application 7. Hence, this ensures that both upstream and downstream traffic routing works seamlessly during handover. Anycast routing doesn't ensure context relocation. This needs to be achieved through the application layer for those applications that require context transfer. Context transfer can be triggered by the MEC platform.
2. in another embodiment of this invention, Application-specific messaging can be utilised to allow the client to re-initiate a connection with the new MEC server. In this approach, the old MEC application 7 would send an application-specific redirect message to indicate that the session should be continued with the new MEC application 7. This will lead the client to either continue communication with the new MEC application 7, or start a new session. The decision will depend on the nature of the application. In some cases, where the application is transactional and does not accumulate context, both actions are identical. In other cases (e.g. file transfer) the application may support context transfer to enable a smooth transition towards the new server.

The decision on whether context transfer is needed depends on the application. Two types of communications exist: 1) Transactional and 2) Continuous. A transaction session is essentially atomic where each transaction is independent from the one prior and future transactions. In some cases, transactional communication is always “fresh” and does not depend on user-specific state. In other cases, the information exchanged depends on user-specific state. In the latter, it is essential that such state is transferred to the “current” MEC application 7.

On the other hand, continuous communication involves dependency between information transferred in the past and the future. Therefore, such communication pattern requires context transfer between MEC applications 7. The context transfer can be implicit, by constantly synchronizing state between MEC applications 7. Alternatively, the Triggered Transfer (TT) can be done at the time of movement from one instance of the application to another.

Implicit Context Transfer (ICT) may be relevant where not many instances of the MEC application are deployed within a network. ICT can consume a lot of bandwidth due to the nature of real time replication. This is further complicated if replication is done within large numbers of instances. Reducing the number of instances within a replication group may involve adding capability to predict the user's mobility in order to expand or reduce the replication group. Hence, due to such complexities, network operators may see a benefit for such method if the application is limited to fewer concentrated instances.

TT is more scalable for large deployments as it is done “on demand”. At the time of handover, the old MEC application 7 would be triggered to send the user's context to the new MEC application 7. The benefit of this approach is its scalability and independence of the number of deployed instances.

Finally, another method for transferring context is one where the application informs the new MEC application 7 of its context. This is feasible in cases where the user's context can be created and essentially authorized by the user himself, represented by the application. For example, if a user is streaming a video, the streaming application can inform the new MEC application 7 of where it needs to continue streaming within a video and that's all the context needed in that case. To contrast this scenario, if the video is not freely available (e.g. purchased), then this approach is insufficient without the inclusion of an authorization token that can be verified by a central function, or ensuring that context transfer takes place between MEC application instances.

The fact that some traffic can be offloaded by the SGW-LBO may render the billing of the usage of traffic complex for the user who uses the offload traffic.

In standard networks, the PGW 4 is responsible for the communication with the Online Charging System

(OCS). It regularly checks whether a user has enough credit to continue with the current service. Post-paid users may have data usage limits that, when exceeded, can result in throttling the current connection or stopping it altogether. On the other hand, pre-paid customers would also need to be actioned if they used up their credit.

Having the traffic steered “out” of the network before it arrives at the PGW 4 would bypass this function and therefore negatively affect the network operation.

The PGW 4 communicates with OCS using the Gy interface as defined in 3GPP specification. The Gy interface uses the Diameter protocol as a container for its messages.

In order to overcome the possible billing problem and consider all the traffic used by the user, the invention provides with different solutions.

In one embodiment of this invention, the PGW 4 is configured with the SGW-LBO functions within the network. The PGW 4 is aware of which customers are connected to which SGW-LBO. The SGW-LBO is configured to breakout certain traffic streams and send a copy of those streams to the PGW 4. The traffic streams are marked to be discarded at the PGW 4 after being counted. This allows the PGW 4 to keep track of the user's data usage, while still achieving the local breakout. In one embodiment of this invention, the traffic is marked using a new flag in the GTP-U packet. In another embodiment of this invention, the traffic is marked using a reserved GTP Tunnel id that can only be used for local breakout traffic. In another embodiment of this invention, the traffic is marked using the IP header. This can be achieved using the QoS field in an IPv4 or IPv6 header (Type of Service field) or using the flow label field in an IPv6 header. In another embodiment of this invention, the SGW-LBO generates records containing the traffic usage for local breakout on a per customer basis. The traffic records generated would be used by the PGW, added to the non-breakout traffic usage to obtain accurate information about the user's data usage. The records generated by the SGW 5 may use the same format of the Charging Data Records (CDR's) currently generated by the SGW 5 but targeted towards the PGW 4. CDRs can be communicated via FTP, Ga interface (using GTP'). Alternatively, within LTE networks 100, GTP-C may be extended to convey this information. The GTP-C protocol is already in use between the SGW 3 and PGW 4 in an LTE architecture.

In yet another embodiment of this invention, the SGW-LBO implements the diameter based Credit Control interface similar to the Gy interface, allowing it to communicate with the OCS and allows the OCS to grant units of traffic and time also to the SGW-LBO for the traffic that is steered. This will allow the OCS to gain accurate knowledge about the user's data usage and provide correct answers regarding any possible over-use of data. Dynamic charging policy can be associated to different users based on the rating group that an entity such as the PCRF can send to the SGW-LBO via the Policy and rule function interface similar to the Gx interface.

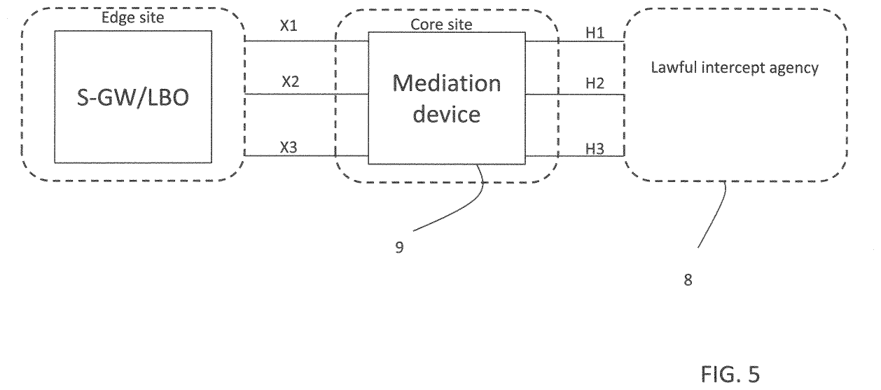

According to another aspect, Lawful Intercept (LI) allows an authorized agency (typically a government agency) to access one or more users' data. In a typical 3GPP architecture this is done by tapping the contact points where the user is connected. ETSI has defined the H1, H2 and H3 interfaces that are required to be supported by the LI agency 8. The LI agency 8 may communicate with the core network 2 directly, or more likely through a mediation service 9. In the latter case, the three interfaces above are translated to interfaces that are used between the mediation service and the core network, or used as is. FIG. 5 shows the approach to LI.

The H1, H2 and H3 interfaces, allow an LI agency 8 to make the following requests, respectively.

1. initiate a request for tapping a user's connection by providing a unique user or device identifier.

2. request that all signalling traffic related to a given user or device be sent to the LI agency

3. receive the given user's traffic.

The X1, X2 and X3 interfaces are shown above as example interfaces corresponding to the H1, H2 and H3 interfaces specified in ETSI standards.

The SGW-LBO device would support the above interfaces for local breakout traffic. To do so, it needs to have access to the user's identifiers exchanged on the H1 interface and apply them to the received traffic. Such information is available to the SGW-LBO currently as it has access to control signalling containing the user and device information. The signalling maybe intercepted and identifiers can be stored locally within the SGW-LBO to satisfy LI impacts. New developments in 3GPP standards like the separation of the control and user plane has led to challenges pertaining to the availability of such information. Innovations for solving these challenges are presented below.

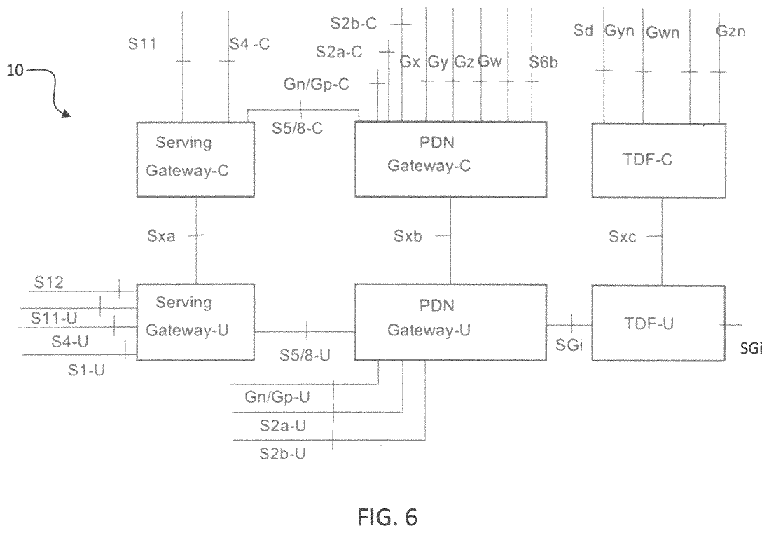

New developments in 3GPP emphasise the need for a Service-based Architecture (SBA) where network functions are distinctly divided into services that communicate with each other using standard protocols. These developments took place in 4G standards and are expected to continue in 5G standards. This includes a clear separation of the Control Plan (CP) and User Plane (UP). The CP is responsible for the communication of information about ongoing sessions or about the mobile network subscribers. This includes everything from address allocation to policy retrieval, QoS enforcement and charging. The UP is solely concerned with forwarding the user's traffic. FIG. 6 illustrates the CP-UP split in the core network. FIG. 6 presents the CP-UP split architecture 10 where control planes represent the PDN (or PGW) and SGW are communicating to the UP using the Sxb and Sxa, respectively. The two CP entities also need to communicate using the existing S5/S8 interface. Such communication is necessary to share information about the GTP tunnel identifier, which is used by the SGW UP to forward packets to the PGW. This architecture, while providing a number of benefits, presents a challenge to the LBO approach presented above. In order for the SGW-LBO to steer traffic “out” of the core network 2, it needs to be aware of policy decisions that can be mapped to incoming traffic on the uplink. This requires knowledge of the ultimate customer's identity and knowledge of the traffic classifiers. It also requires knowledge of the customer's APN. Such information is not shared in the CP-UP split architecture 10.

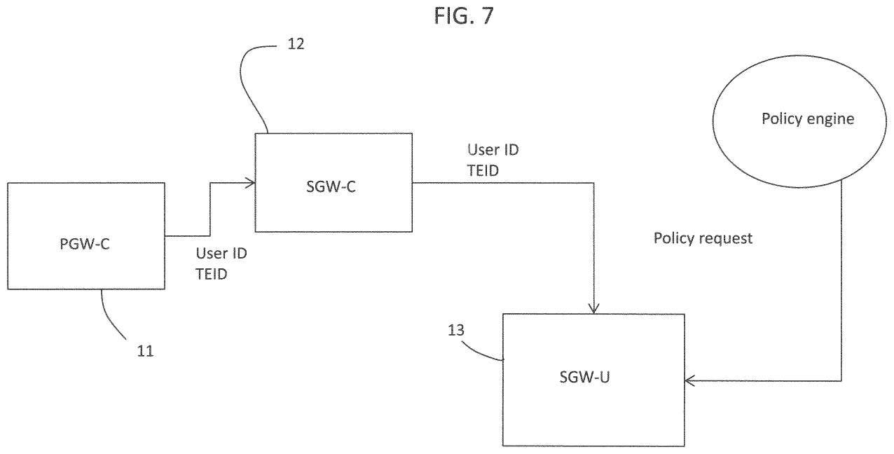

In one embodiment of this invention, the mapping of the user's identity, the corresponding allocated IP address and APN is transferred from the PGW-C 11 to the SGW-C 12 and from the SGW-C 12 to the SGW-U 13 entities in order to ensure that the forwarding plane is aware of the user's identity associated with the allocated IP address. This allows the SGW-U 13 to enforce the required forwarding policies requested by the operator. In this approach, the operator interacts with the SGW-U 13 directly, knowing that it has all the information required. FIG. 7 shows PGW-C to SGW-C to SGW-U sequence. Sharing such information requires triggers in the control plane to provide the information at:

1. address allocation

2. bearer (default or dedicated) assignment.

In one embodiment of this invention, the information may be stored by the PGW-C 11 and communicated to the SGW-C 12 once the entire sequence of address and bearer assignment is executed.

In another embodiment of this invention, the information is transferred in real time and sored piece-meal in the SGW-U 13 until the complete sequence of address and bearer assignment is executed.

In another embodiment of this invention, the information about the mapping of the GTP tunnel identifier (TEID) to the user's identity, APN and allocated addresses is stored in the SGW-C 12 as provided by the PGW-C 11. The operator's requests for traffic steering, are sent to the SGW-C 12 controlling the domain where the user is located. The SGW-C 12, having all the information needed, would send the request for traffic steering for the SGW-C 12. The request would only include the GTP TEID and the required forwarding rule.

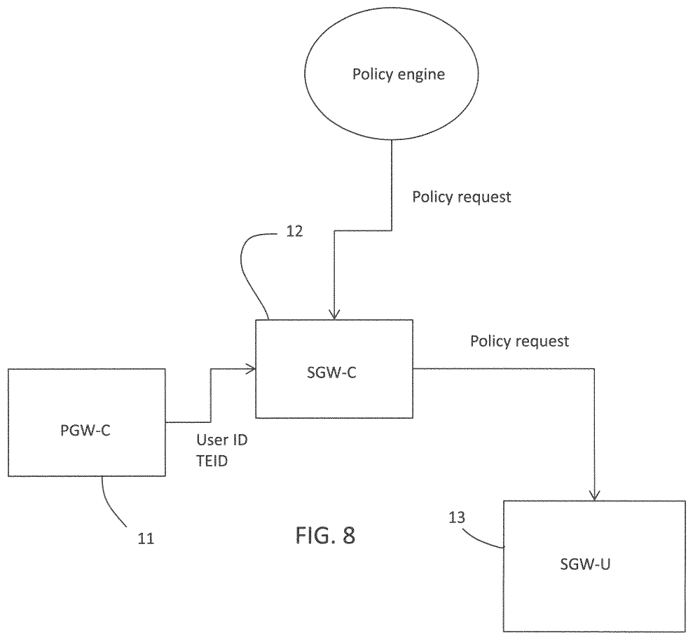

FIG. 8 shows the above MEC-SGW-C-SGW-U sequence.

In another embodiment of this invention the dynamic policy engine is the PCRF and the policy it transferred to the SGW-LBO using a policy and the rule interface similar to the Gx or Gxx. This allow to use existing network functions and interfaces to dynamically apply the steering rules.

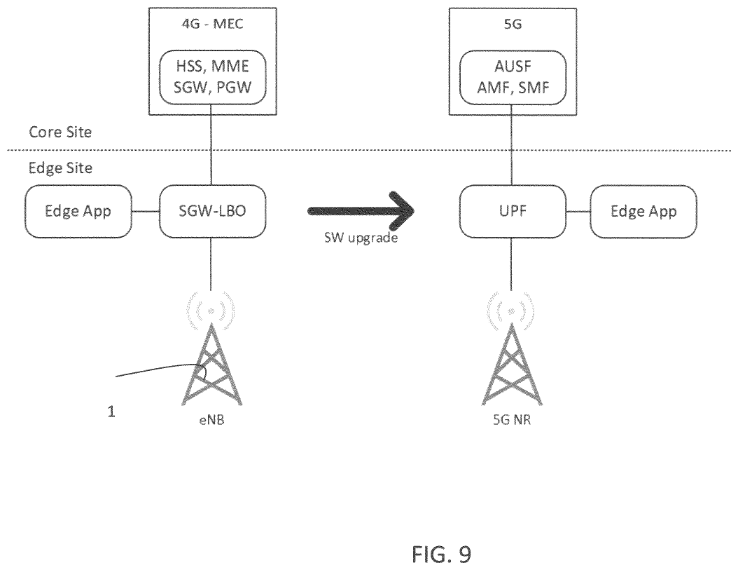

5G networks are currently being standardised by 3GPP. The principles of CP-UP separation described above are used in 3GPP standards for 5G networks. CP functions are aggregated in two key components, the Authentication and Session Management functions (AMF and SMF, respectively). In such architecture, the communication described above between the CP and UP for supporting local traffic steering “out” of the core network can be achieved by sharing the information directly between the SMF and the User Plane function (UPF) shown in FIG. 9 below.

In one embodiment of this invention, the user's identity, allocated addresses and forwarding rules are all transferred from the SMF to the UPF after the authentication and bearer establishment process is successfully completed. Hence, the operator's request may be sent directly to the UPF, where all the information is available for applying the forwarding rules.

In another embodiment of this invention, the SMF stores the user's identity, allocated addresses for all users within its domain locally. Operator's requests may be sent to the SMF for a given user, this request is then translated to the identities relevant within the context of the UPF and sent together with the requested forwarding rules to the UPF. Information relevant to the UPF may include the Tunnel identifier, user's IP address or both. This approach limits the spread of the user's identity within the network while enabling local breakout to take place.

In another embodiment of this invention, the information may be “pulled” from the policy engine “on demand”. That is, any entity in the aforementioned sequence, may request a forwarding policy based on a specific session information. For example, the SGW-C 12 or SGW-U 13 (SMF or UPF in LTE or 5G, respectively) may provide session information to a policy engine and request the forwarding rules for that session. Session information may contain traffic descriptors (source and destination addresses and ports), the user identifier, whether the traffic is encrypted with IPsec, the Flow label (IPv6) or Type of Service (ToS) field content (Diffserv), among other potential information known about the user, or contained in the IP packet.

The aforementioned charging and lawful intercept impacts and their solutions would also apply directly to 5G networks where the UPF is essentially performing similar functions to the SGW-U entity in LTE networks. Therefore, the same inventions apply within the 5G context.

Acronyms
API Application Programming Interface
CDR Charging Data Record
CGW Charging Gateway
eNB evolved Node B
EPC Evolved Packet Core
FTP File Transfer Protocol
HSS Home Subscriber Service
IMS IP Multimedia Subsystem
LBO Local Break Out
LTE Long Term Evolution
MME Mobility Management Entity
MNO Mobile Network Operator
P-GW Packet Data Network Gateway
QoS Quality of Service
RAN Radio Access Network
SAE-GW System Architecture Evolution Gateway. The SAE-GW includes both S-GW and P-GW
S-GW Serving Gateway

1. A method for charging a user identified by a user identifier accessing a service in [[a]] an LTE telecommunication network, said telecommunication network including a base station, a core network with an enhanced serving gateway function (SGW-LBO), and an IP network, the method including the steps of:
analyzing all traffic packets originating from the user which connects to the network;
forwarding the traffic packet to the core network if the traffic packet or the user sending the packet does not satisfy the policy or the service is not available at the edge site;
offloading traffic packet outside the core network if the packet meets the policies configured in the serving gateway;
wherein routing of the traffic packet is done by the serving gateway; and
sending from the serving gateway information about the offload traffic packets to the packet data network gateway located in the core network or to an Online Charging System.

2. The method according to claim 1, further comprising: sending a copy of the offload packets from the serving gateway to the packet data network gateway.

3. The method according to claim 2, further comprising: marking the copy of the offload traffic packet.

4. The method according to claim 3, wherein the marking includes reserving a GTP tunnel id and marking the copy with the reserved id.

5. The method according to claim 3, wherein the marking includes marking a field in the IP header of a traffic packet.

6. The method according to claim 1, further comprising generating by the serving gateway records containing a traffic usage of offload traffic packets on a per user basis.

7. The method according to claim 1, including extending the serving gateway so that the serving gateway implements a Gy interface to communicate with the Online Charging System.
